(19) United States
(12) Patent Application Publication
(10) Pub. No.: US 2004/0206618 A1
(43) Pub. Date: Oct. 21, 2004

(54) Foam type catalyst system in non-thermal plasma catalytic reactor

(76) Inventor: Gerald E. Voecks, Fairport, NY (US)

Correspondence Address: HARNESS, DICKEY & PIERCE, P.L.C., P.O. BOX 828, BLOOMFIELD HILLS, MI, 48303, US

(21) Appl. No.: 10/414,616

(22) Filed: Apr. 16, 2003

(51) Int. Cl. B01J 19/08

(52) U.S. Cl. 204/164; 422/186.04

(57) ABSTRACT

A catalyst system is provided that can be used, for example, in a water-gas shift reactor of a fuel processor. The catalyst system includes a foam-type catalyst support structure and a non-thermal plasma generation device for generating a non-thermal plasma in the catalyst bed in order to enhance the catalytic reaction taking place in the catalyst bed. The use of the foam catalyst support structure allows the plasma to permeate throughout the catalyst bed structure.

### FIELD OF THE INVENTION

The present invention relates to fuel cell systems, and more particularly, to a catalytic reactor for use in a fuel processor of a fuel cell system.

### BACKGROUND AND SUMMARY OF THE INVENTION

Fuel cells have been proposed as a power source for a variety of applications, including electrical vehicular power plants replacing internal combustion engines. In proton exchange member (PEM) type fuel cells, hydrogen is supplied to an anode of the fuel cell and oxygen is supplied as an oxidant to the cathode of the fuel cell. PEM fuel cells include a membrane electrode assembly (MEA) comprising a thin, proton transmissive, non-electrically conductive, solid polymer membrane-electrolyte having the anode on one of its faces and the cathode on the opposite face.

In PEM fuel cells, hydrogen (H₂) is implemented as the anode reactant and oxygen (O2) is implemented as the cathode reactant. For vehicular and other applications, it is desirable to use a liquid fuel, such as gasoline, diesel, methanol and the like as a source of hydrogen for the fuel cell. Such liquid fuels must be dissociated by releasing the hydrogen content thereof. The dissociation reaction is generally accomplished in an autothermal reformer. An exemplary process is the air/steam/methane reformation process where methane air and water (steam) are ideally reacted to generate hydrogen and carbon oxides according to the reaction:

2CH₄+3H₂O+0.5O₂(air)→CO+CO₂+6H₂

The resultant hydrogen is then utilized in the fuel cell to react with oxygen to create electricity which can be utilized to run an electric motor or for other purposes depending upon the ultimate use of the fuel cell system. A typical fuel processor often includes a fuel inlet, a primary reactor such as an autothermal reformer (ATR), a watergas shift (WGS) reactor, and a preferential oxidation reactor (prox). Typically, the fuel, air, and steam are mixed and are heated at the inlet at which point they enter the primary reactor. Once the fuel is mixed and sent into the primary reactor, it is split into hydrogen and carbon oxides by flowing the mixture over a catalyst. Typical catalyst materials include platinum group metals and base metals. This reaction occurs at temperatures in the range of 700 to 800 degrees Celsius.

The fuel stream leaving the primary reactor enters the watergas shift reactor where carbon monoxide is reduced using another catalyst. The reaction CO+H₂O→CO₂+H₂ involves the final oxidation of carbon monoxide to carbon dioxide with steam being the oxidant. This results in the production of a mole of hydrogen for every mole of carbon monoxide reacted. The fuel stream leaving the watergas shift reactor enters the preferential oxidation reactor where final clean up of carbon monoxide takes place before the hydrogen rich stream enters the fuel cell stack. Air is added to supply the oxygen needed to convert most of the remaining carbon monoxide to carbon dioxide, leaving additional hydrogen behind. Combined, the three reactors generate a hydrogen rich gas stream from the fuel for use by the PEM stack. Since the effective conversion of hydrocarbon fuel is dependant upon the efficient operation of the catalyst of the reactors, it is desirable to improve the thermal and conversion efficiency of the reactors under varying operating conditions.

Accordingly, the present invention uses a non-thermal gas plasma environment to enhance or accelerate a reaction that takes place in a catalytic system. In particular, the present invention provides a catalytic system which is provided in a flow passage and includes a catalyst structure disposed in the flow passage and a non-thermal plasma generator for generating a non-thermal plasma in at least a portion of the catalyst structure. The present invention utilizes an open cell structure for catalyst support, not unlike a “foam” or “sponge.” The open cell structure differs from a closed cell or honeycomb structure and from a packed catalyst bed which is a collection of several independent pellets, tablets, rings, etc. that are packed together and form variable flow paths. The open cell foam catalyst is provided with voids or pores throughout the foam structure to (1) allow for easy generation and propagation of the plasma produced by the plasma generator, and (2) provide active catalyst surfaces throughout the catalyst bed. The plasma generator can employ electrical or microwave generation of the non-thermal plasma.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic view of a fuel cell system including a watergas shift (WGS) reactor according to the principles of the present invention;

FIG. 2 is a cross-sectional view of a watergas shift reactor according to the principles of the present invention;

FIG. 3 is a cross-sectional view of a watergas shift reactor utilizing a microwave generated plasma in the catalyst bed according to the principles of the present invention; and

FIGS. 4a-4c are graphical illustrations of the conversion of carbon monoxide to carbon dioxide using the foam-type catalyst system in a plasma catalytic reactor using different steam to carbon monoxide ratios.

### DETAILED DESCRIPTION OF THE PREFERRED EMBODIMENTS

The following description of the preferred embodiment(s) is merely exemplary in nature and is in no way intended to limit the invention, its application, or uses.

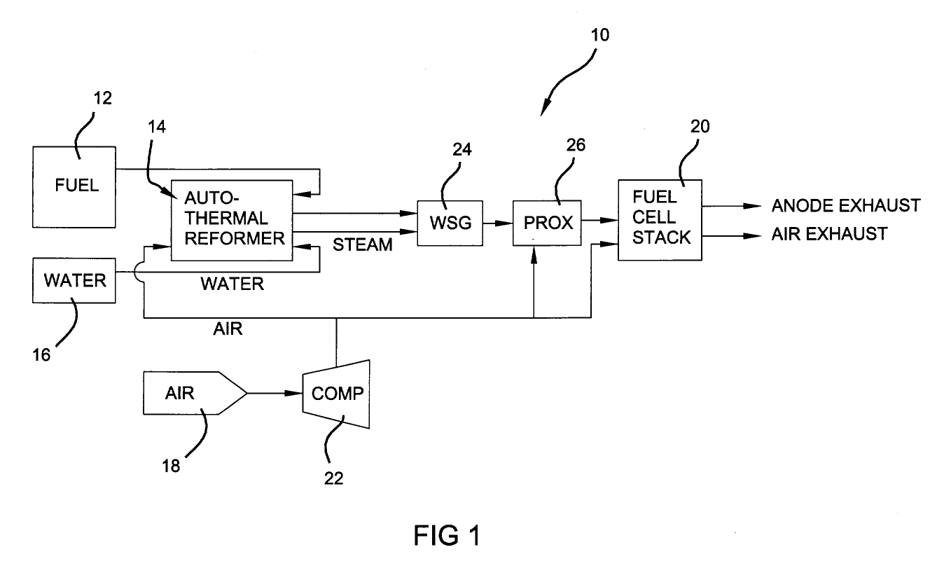

With reference to FIG. 1, an exemplary fuel cell system 10 is shown. The system 10 includes a fuel tank 12 for supplying a hydrocarbon fuel, such as, but not limited to, gasoline, to an autothermal reformer 14. Further, a water tank 16 and an air source 18 are also included for respectively providing water and air to the autothermal reformer 14. Air is further supplied to a fuel cell stack 20 and is driven through the system by a compressor 22.

The autothermal reformer 14 dissociates the hydrocarbon fuel using steam and air that reacts with the hydrocarbon fuel for producing a hydrogen-rich reformate. The autothermal reformer 14 actually yields a reformate gas comprising hydrogen, carbon monoxide, carbon dioxide, and water. The carbon monoxide content of the reformate stream is generally too high whereby direct use in the fuel cell stack 20 would result in the fuel cell stack 20 being poisoned. Therefore, from the autothermal reformer 14, the produced reformate stream flows to a WGS reactor 24 constructed in accordance with the principles of the present invention, and further into a preferential oxidation (PROX) reactor 26 for reducing the carbon monoxide content to an acceptable level. The reformate stream then goes to the fuel cell stack 20.

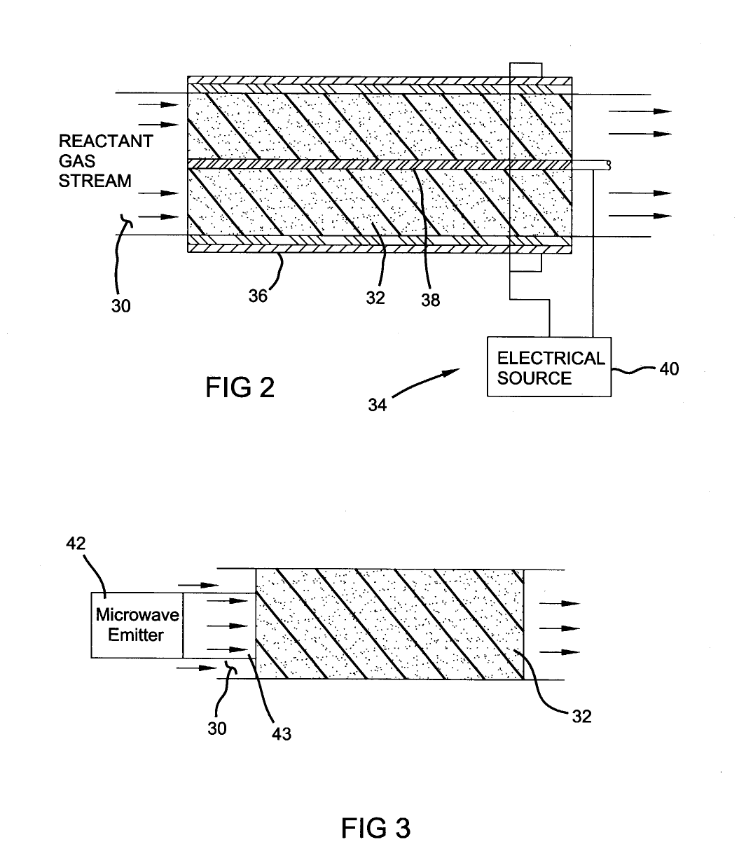

With reference to FIG. 2, a WGS reactor 24, according to a first preferred embodiment of the present invention will now be described. Within the WGS reactor 24, water (as steam) is added to the reactant gas stream provided from the autothermal reformer 14. The WGS reactor 24 is provided with a flow passage 30 including a catalyst bed 32 disposed therein. A plasma generator device 34 is provided for generating a non-thermal gas plasma within the catalyst bed 32.

According to a preferred embodiment of the present invention, the catalyst bed 32 includes a foam support structure made of a non-conducting material such as ceramic. The foam support is provided with open cells and has a porosity of approximately 10 to 100 pores per inch (PPI). The porosity of the catalyst bed and the size of the flow passage are selected to provide a sufficient flow of the reactant gas stream therethrough in order to provide an appropriate pressure drop, reactant gas interaction with catalyzed surfaces, and adequate gas plasma penetration throughout the catalyst bed. A catalyst material is coated on the foam support structure. Exemplary catalyst materials include, but are not limited to: copper/zinc oxide combinations and noble metal or metal oxides, representing typical low temperature water gas shift catalysts. Other porous support structures may also be utilized and other catalyst systems may be supported on these structures. Variables that can be employed are support material composition, support wall thickness, pore density of the foam-design structure, catalyst type, catalyst loading, and catalyst bed geometry.

The plasma generating device as shown in FIG. 2 is known as a corona discharge-type and includes an electrode 36 which circumferentially surrounds the catalyst bed 32 and an axially extending second electrode 38 which extends axially through the first cylindrical electrode 36. An electrical source 40 is connected to the first and second electrodes 36, 38 and preferably provides electrical pulses to the first and second electrodes 36, 38 at such a voltage and duration so as to generate a non-thermal plasma that permeates the catalyst bed 32, but that does not permit arching between the first and the second electrodes. By providing short duration pulses, a non-thermal plasma can be generated without permitting an arc to fully develop.

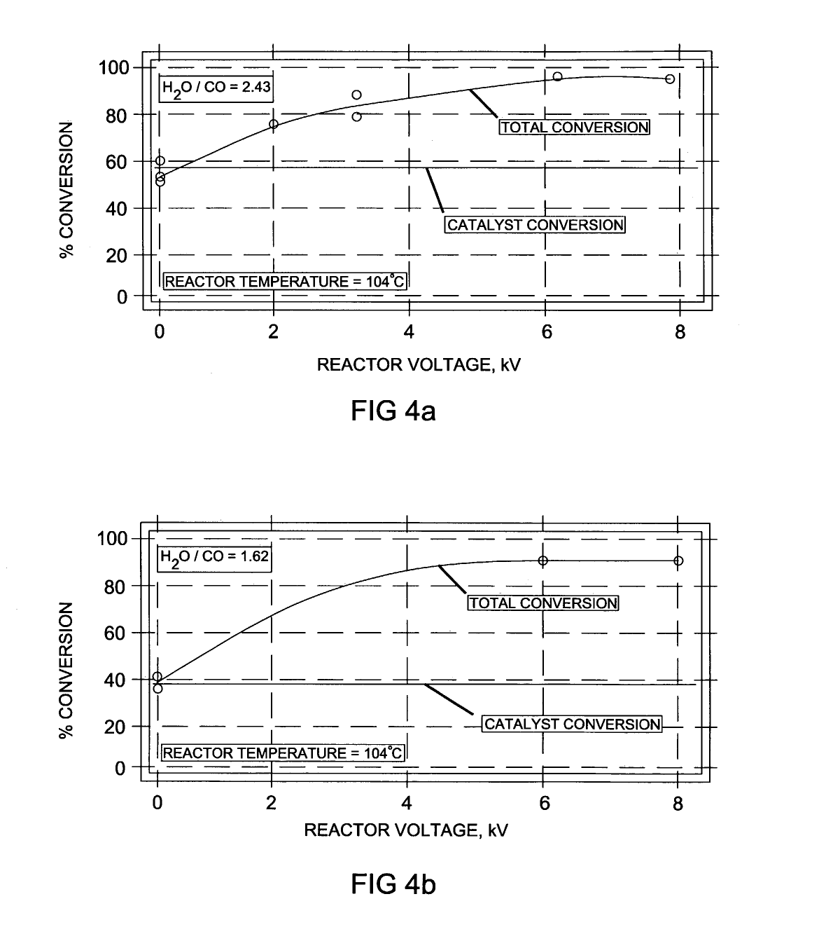

An alternative gas plasma generating device could include a microwave emitting device 42 as illustrated in FIG. 3. According to this embodiment, a microwave emitting device 42 is provided with a wave guide 43 for directing microwaves to the flow passage 30 for emitting microwave electric discharges into the catalyst bed 32 for generating a plasma therein.

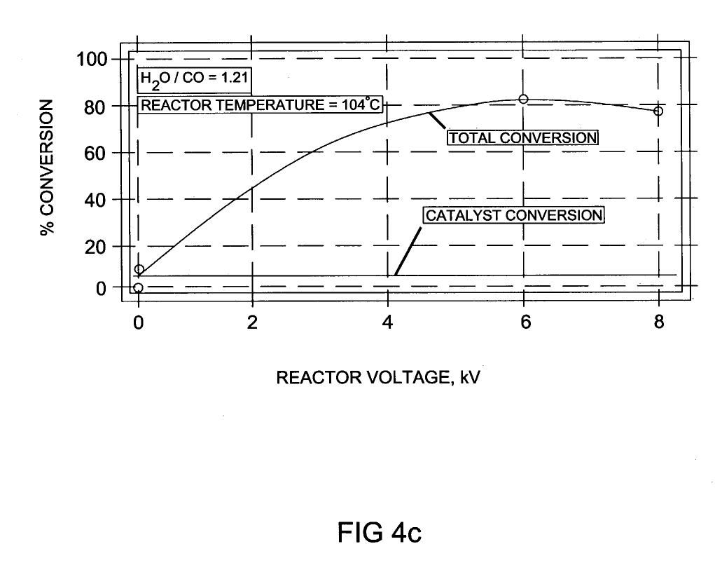

A corona discharge, non-thermal plasma, WGS reactor, such as the one illustrated in FIG. 2, was tested utilizing an open cell ceramic foam catalyst bed support with 30 pores per inch. Each of the tests were conducted using a reactor temperature of approximately 100° C. while the voltage applied to the plasma generating device varied from zero to approximately eight kilovolts. Pulse rates can vary to assure the plasma is maintained at a non-thermal condition. For the test results illustrated in FIG. 4a, the ratio of steam (H₂O) to carbon monoxide (CO) present in the reformate gas was 2.43. As graphically illustrated in FIG. 4a, the conversion percentage of carbon monoxide to carbon dioxide for the catalyst alone was approximately 58 percent without the use of the plasma generator, as illustrated by the line labeled “CATALYST CONVERSION.” As illustrated by the line labeled “TOTAL CONVERSION,” the conversion percentage of carbon monoxide to carbon dioxide increased with the generation of a gas plasma in the catalyst bed. For example, the conversion percentage of carbon monoxide to carbon dioxide increased to approximately 80 percent with the plasma generator being supplied with approximately 2.7 kilovolts, and the conversion percentage was optimized at above 90 percent with a plasma generator voltage of approximately six kilovolts. The “TOTAL CONVERSION” curve illustrates the improved conversion efficiency that was obtained by use of the plasma generator as compared to the catalyst conversion obtained using the catalyst only which achieved just under 60 percent conversion.

In a second experimental example that was conducted, all of the parameters of the prior test were maintained except that the ratio of steam (H₂O) to carbon monoxide (CO) was reduced to 1.62. As can be seen from FIG. 4b, the amount of carbon monoxide converted due to the catalyst alone was just below 40 percent, as illustrated by the line labeled “CATALYST CONVERSION.” The line labeled “TOTAL CONVERSION” demonstrates that the total amount of carbon monoxide converted was significantly increased by use of the non-thermal plasma. For example, a conversion percentage of approximately 90 percent was obtained with a six kilovolt voltage supplied to the non-thermal plasma catalytic reactor.

In a third test example, the amount of steam was reduced further to provide a steam to carbon monoxide ratio of 1.21. The results of the third test are shown graphically in FIG. 4c. The amount of conversion due to the catalyst alone was less than 10 percent as illustrated by the line labeled “CATALYST CONVERSION” while the line labeled “TOTAL CONVERSION” illustrates the amount of conversion obtained with the reactor voltage ranging from zero to eight kilovolts. As can be seen, a conversion percentage of approximately 80 percent was obtained by applying six kilovolts as a reactor voltage.

The test results above demonstrate that even in a mixture of gases that has a steam amount that is less than normally provided for efficient conversion in a standard WGS reactor, high conversion percentages can be obtained by generating a non-thermal plasma within the catalyst bed. Since the amount of steam that is added to the reformate gases must eventually be reclaimed. The reduction in the amount of steam introduced to the reformate gases without reducing the conversion efficiency is highly desirable.

The use of a foam-type of catalyst structure in combination with a non-thermal plasma environment to enhance or accelerate a catalyst reaction provides several advantages. Since the foam monolith is rigid, compared to a packed bed, friable destruction of the support is avoided. In addition, the voids within the foam structure walls allow for easy generation and propagation of the non-thermal plasma produced by the electrical or microwave source. The catalyst can be uniformly and controllably available on the walls of the foam catalyst support structure from centerline to wall and inlet to exit. In addition, the foam structure can be selected from varying pore densities (pores per inch) throughout the bed, and by varying the catalyst support material, the catalyst type and the loading.

The method of plasma generation and manifestation throughout the catalyst bed is more advantageous than the use of a honeycomb-type monolith catalyst structure because of the ease of communication of reactants and gas plasma throughout the catalyst bed as the reactants flow down the length of the catalyst/plasma reactor bed. A method of utilizing a non-thermal creates a more uniform reaction environment to activate the catalyst via either the activated reactant gas or by direct activation of the catalyst “hot” plasma electrons or by surface excitation that results from plasma generation.

The introduction of a non-thermal plasma to the catalyst bed provides a much faster initiation of reaction and provides a rapid start up for such reactions as water-gas shift. By enhancing the catalyst activation, the catalyst bed sizes may be reduced while still meeting required capacities.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A catalyst system, comprising:
a flow passage:
a catalyst structure disposed in said flow passage; and
a non-thermal plasma generator for generating a non-thermal plasma in at least a portion of said catalyst structure.

2. The catalyst system according to claim 1, wherein said catalyst structure includes a foam catalyst structure.

3. The catalyst system according to claim 2, wherein said foam catalyst structure is one of a non-conducting an semi-conducting material.

4. The catalyst system according to claim 1, wherein said non-thermal plasma generator includes a first electrode and a second electrode.

5. The catalyst system according to claim 4, wherein said non-thermal plasma generator includes an electric pulse generating mechanism for generating electric pulses to be supplied to said first and second electrodes.

6. The catalyst system according to claim 4, wherein said first electrode is generally cylindrical and said second electrode is disposed axially inside said first electrode.

7. The catalyst system according to claim 1, wherein said non-thermal plasma generator includes a microwave generator that emits microwaves that are directed to said flow passage.

8. The catalyst system according to claim 1, wherein said catalyst structure includes open areas to allow a non-thermal plasma to propagate axially and radially within said catalyst structure.

9. The catalyst system according to claim 1, wherein said non-thermal plasma generator is a pulsed corona discharge-type plasma generator.

10. A method of catalytically converting a first gaseous medium to a second gaseous medium, comprising the steps of:
providing a catalyst structure in a flow passage;
generating a non-thermal plasma in said catalyst structure; and
flowing the first gaseous medium through said flow passage for converting said first gaseous medium to a second gaseous medium.

11. The method according to claim 10, wherein said catalyst structure is a foam catalyst structure.

12. The method according to claim 11, wherein said foam catalyst is an open cell foam with between 10 and 100 pores per inch.

13. The method according to claim 12, wherein said foam catalyst structure is a ceramic.

14. The method according to claim 10, wherein said step of generating a non-thermal plasma in said catalyst structure includes providing electric pulses to a first and a second electrode to create an electric field in said catalyst structure.

15. The method according to claim 10, wherein said step of generating a non-thermal plasma in said catalyst structure includes providing microwaves in said catalyst structure.

16. The method according to claim 10, wherein said step of generating a non-thermal plasma in said catalyst structure includes using a pulsed corona discharge-type plasma generator.

17. A catalyst system, comprising:
a housing defining a flow passage;
a foam catalyst disposed in said flow passage, said foam catalyst having open cells that communicate in a longitudinal and a lateral direction relative to a direction of flow in said flow passage.

18. The catalyst system according to claim 17, further comprising a plasma generator for generating a non-thermal plasma in at least a portion of said foam catalyst.

19. The catalyst system according to claim 18, wherein said plasma generator includes a first electrode and a second electrode.

20. The catalyst system according to claim 19, wherein said plasma generator includes an electric pulse generating mechanism for generating electric pulses to be supplied to said first and second electrodes.

21. The catalyst system according to claim 19, wherein said first electrode is generally cylindrical and said second electrode is disposed axially inside said first electrode.

22. The catalyst system according to claim 17, wherein said foam catalyst has a ceramic structure.

23. The catalyst system according to claim 18, wherein said plasma generator includes a microwave generator that emits microwaves generally orthogonal to said flow passage.

24. The catalyst system according to claim 18, wherein said plasma generator is a pulsed corona discharge-type plasma generator.
